(19) United States
(12) Patent Application Publication
(10) Pub. No.: US 2008/0098679 A1
(43) Pub. Date: May 1, 2008

(54) Waterproof gate assembly structure

(76) Inventor: Tien Chan, Sijhih City (TW)

Correspondence Address: Troxell Law Office Pllc, Suite 1404, 5205 Leesburg Pike, Falls Church, VA, 22041, US

(21) Appl. No.: 11/589,306

(22) Filed: Oct. 30, 2006

(51) Int. Cl. E06B 11/02

(52) U.S. Cl. 52/302.1

(57) ABSTRACT

A waterproof gate assembly structure is constituted by a sheathing layer, a nozzle, an inflatable inner casing, iron pieces, and screw-holes, wherein the sheathing layer is fixed on a wall by transfixing fixing screws into the screw-holes, small holes, and pads, and an exterior of the sheathing layer is provided with the nozzle which is extended to the inflatable inner casing in the sheathing layer. Gas can be filled into the inflatable inner casing through the nozzle, until it is full, such that an unfilled space can be more tightly filled, thereby achieving an effective waterproof function. In addition, the sheathing layer is also provided with locking elements for taking out and replacing the inflatable inner casing.

### BACKGROUND OF THE INVENTION

(a) Field of the Invention

The present invention relates to a waterproof gate assembly structure, and more particularly to a waterproof gate assembly structure, wherein one side of a sheathing layer of which is provided with locking elements to replace an inflatable inner casing installed inside the sheathing layer and provided with a nozzle, with the nozzle being extended outward to the sheathing layer, such that gas can be filled into the inflatable inner casing until it is full.

(b) Description of the Prior Art

Referring to FIG. 1 and FIG. 2, a conventional waterproof gate is composed of locking grooves A1 and a baffle A2, wherein the locking grooves A1 should be first fixed at two sides of a wall A3 respectively, such that when the gate is used, the baffle A2 can be emplaced into the locking grooves A1. However, as there is no any sealing material between the baffle A2 and locking grooves A1, an effect of waterproof is not perfect.

Accordingly, how to eliminate the aforementioned problem is a technical issue to be solved by the present inventor.

### SUMMARY OF THE INVENTION

The primary object of present invention is to provide a waterproof gate assembly structure, wherein one side of a sheathing layer of which is provided with locking elements to replace an inflatable inner casing which is located inside the sheathing layer, and the inflatable inner casing is provided with a nozzle which is extended outward to the sheathing layer. Gas can be filled into the inflatable inner casing through the nozzle until it is full, so as to more tightly fill a space that has not been filled completely, thereby achieving a function of waterproof.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of a conventional waterproof gate.

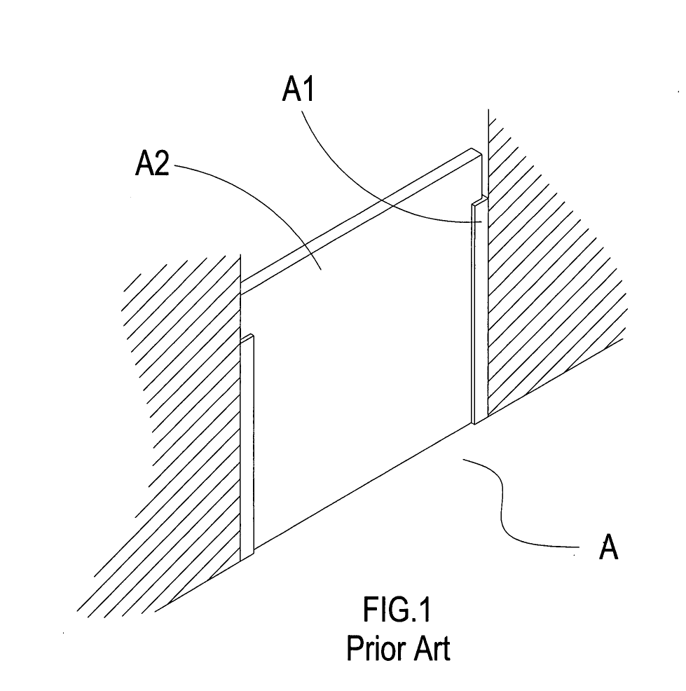

FIG. 2 shows a schematic view of an embodiment of conventional waterproof gate.

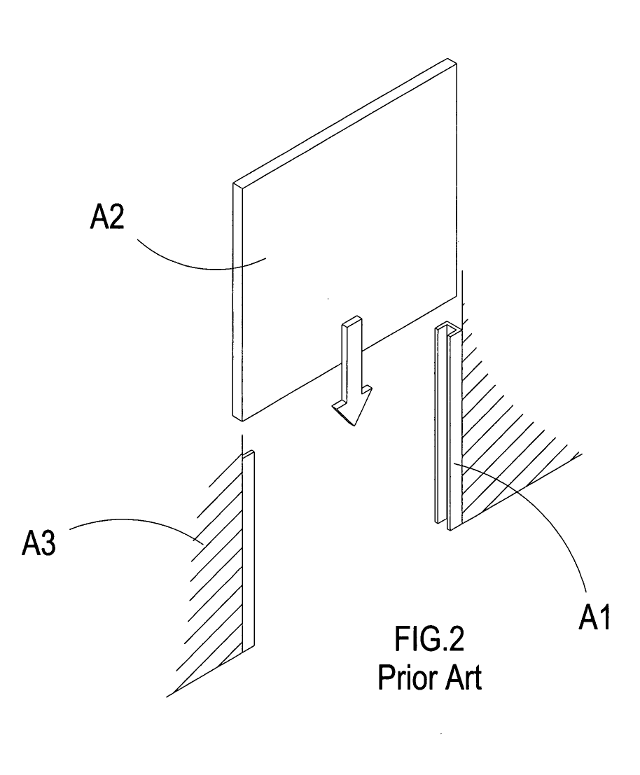

FIG. 3 shows a perspective view of the present invention.

FIG. 4 shows an exploded view of the present invention.

FIG. 5 shows a schematic view of an embodiment of the present invention.

FIG. 6 shows a second schematic view of an embodiment of the present invention.

FIG. 7 shows a third schematic view of an embodiment of the present invention.

### DETAILED DESCRIPTION OF THE PREFERRED EMBODIMENTS

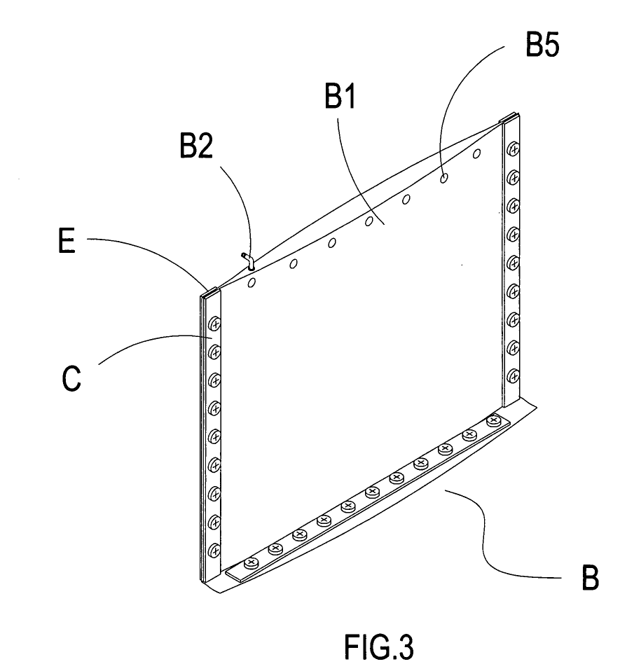

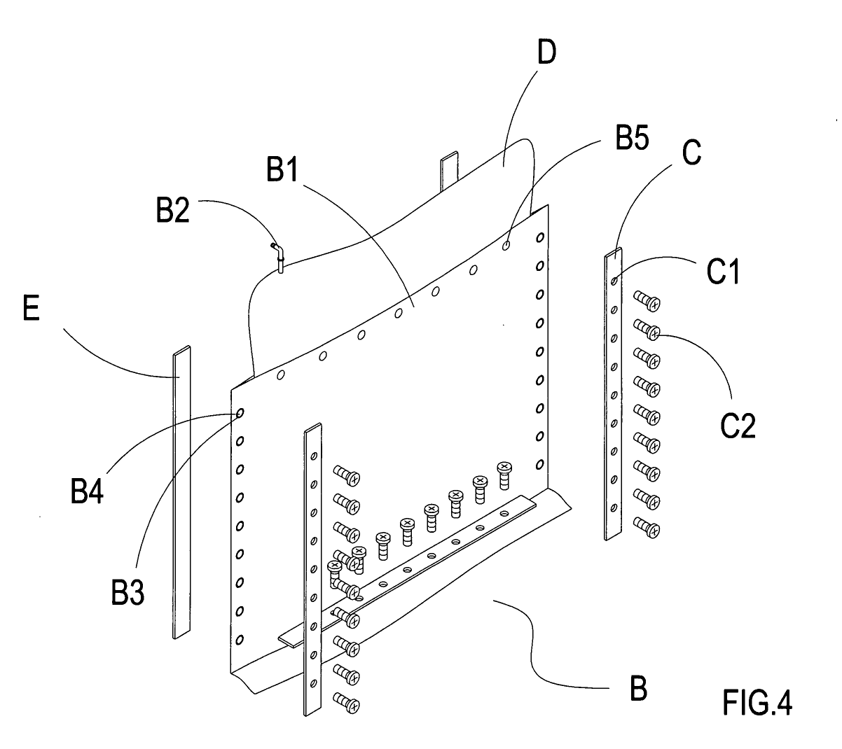

Referring to FIG. 3 and FIG. 4, a waterproof gate assembly structure B of the present invention comprises a sheathing layer B1, a nozzle B2, iron pieces C, screw-holes C1, and fixing screws C2. An interior of the sheathing layer B1 is installed with an inflatable inner casing D on which is provided with the nozzle B2 being extended toward an exterior of the sheathing layer B1. Gas can be filled into the inflatable inner casing D through the nozzle B2 until it is full, and a plurality of small holes B4 is located at edges of two sides and a lower side of the sheathing layer B1, and is latched with boots B3, such that the small holes B4 will not be damaged from a multiple time of usage. In addition, an upper side of the inflatable inner casing D is provided with a plurality of locking elements B5 to provide for a replacement of the inflatable inner casing D.

As the small holes B4 of sheathing layer B1 cannot be fixed on a wall, the iron pieces C should be used as a fixing medium. The iron pieces C are provided with the plural screw-holes C1 which are corresponding to the small holes B4 on the sheathing layer B1.

Accordingly, when the waterproof gate B is used, the sheathing layer B1 can be more rigidly fixed on the wall by using the iron pieces C and pads E, such that a function of waterproof can be more enhanced for the waterproof gate B.

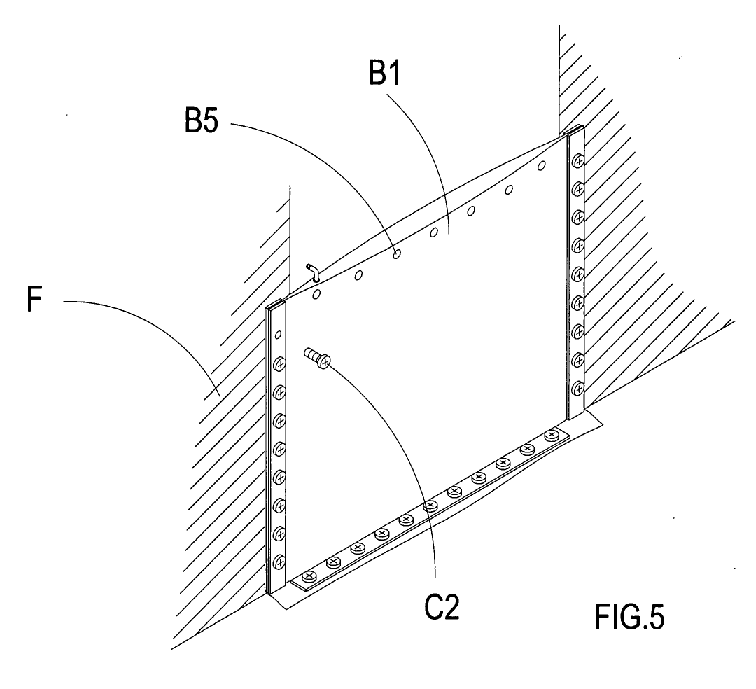

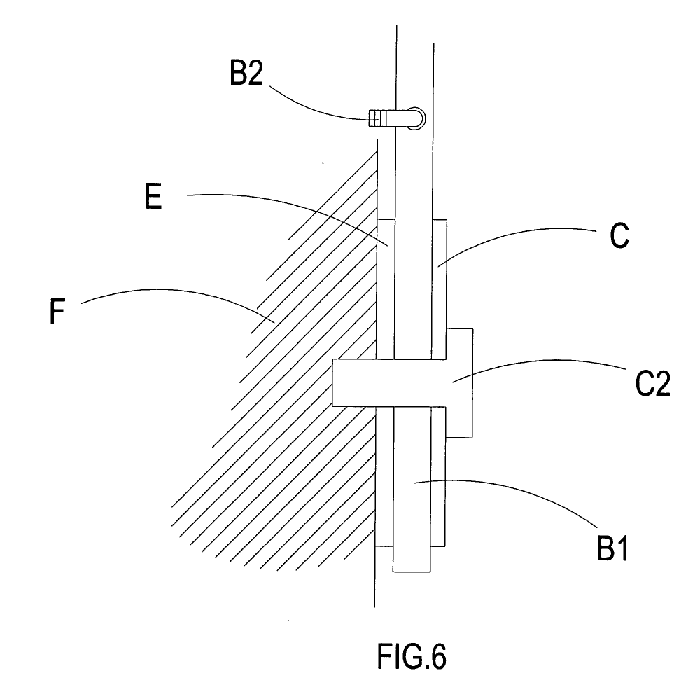

Referring to FIGS. 4 to 6, as the two sides and lower side of the sheathing layer B1 are provided with the plural small holes B4 which are latched with the boots B3, therefore if a user is using the structure of present invention, he or she should align the plural screw-holes C1 on the iron pieces C with the plural small holes B4 on the sheathing layer B1. Moreover, the pads E are placed between the sheathing layer B1 and a wall F, such that the fixing screws C2 are transfixed into the small holes B4, the screw-holes C1, and the pads E, to be latched into the wall F, wherein the upper side of sheathing layer B1 is provided with the plural locking elements B5 for providing at any time the replacement of the inflatable inner casing D or the sheathing layer B1 when it is damaged, thereby saving a usage of resource.

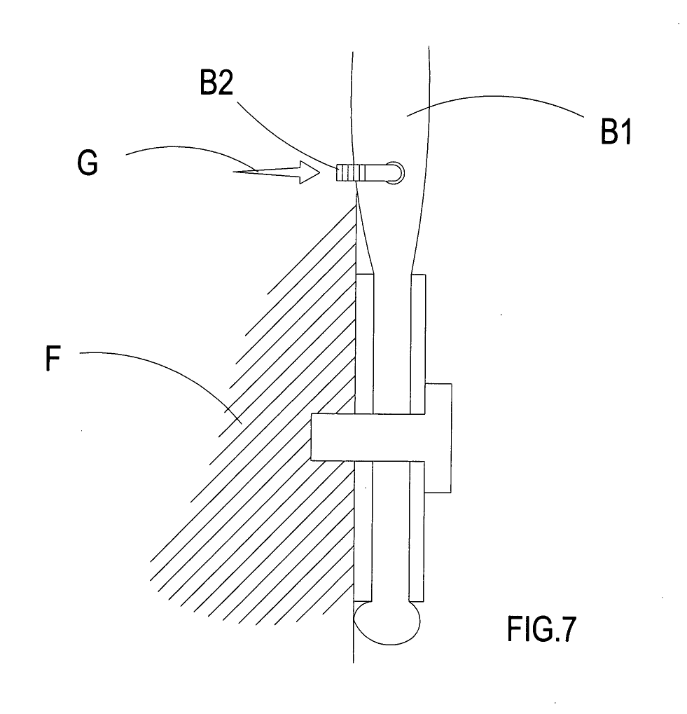

Referring to FIG. 7, the sheathing layer B1 is provided with the nozzle B2 which is extended to the inflatable inner casing D in the sheathing layer B1. When the structure is used, gas G is filled into the inflatable inner casing D through the nozzle B2, until it is full, such that an empty space between the sheathing layer B1 and the wall F which has not been filled can be more tightly filled, thereby achieving the function of waterproof.

On the other hand, the sheathing layer B1 can be further made by a canvas, a plastic fiber, or other related soft material which is waterproof. In addition, as the sheathing layer B1 is made by the soft material, it is convenient to collect, without easily occupying a part of its space.

As the sheathing layer B1 cannot be tightly attached on the wall F, the pads E are added between them to enhance the tightness, wherein the pads E can be further made by a rubber, a plastic, a mackintosh, and other related material which is tight and soft.

To further manifest the advancement and practicability of the present invention, the present invention is compared with a conventional waterproof gate as follow.

Shortcomings of a conventional waterproof gate
1. As there is no any sealing material between the sheathing layer and the wall, the waterproof function is inferior.
2. The baffle is formed integrally and is oversized; therefore it is not easy to collect.

Advantages of the present invention
1. The sealing material is installed between the sheathing layer and the wall, which improves the waterproof function.
2. As the sheathing layer is made by the soft material, it is easy and convenient to collect.
3. As the sheathing layer is provided with the locking elements, when the inflatable inner casing or the sheathing layer is damaged, either one can be replaced at any time, thereby achieving the saving of resource.
4. It has the advancement and practicability.
5. It can improve an industrial competitiveness.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A waterproof gate assembly structure including a sheathing layer, iron pieces, an inflatable inner casing, a nozzle, locking elements, and screwing elements, wherein a canvas is provided with a plurality of screw-holes, and is fixed on a wall by transfixing fixing screws into the screw-holes; the sheathing layer being provided with the inflatable inner casing, and when the inflatable inner casing being full, an unfilled space being filled, in order to achieve a waterproof function; one side of the sheathing layer being provided with the locking elements for replacing the inflatable inner casing, thereby achieving a purpose of saving resource.

2. The waterproof gate assembly structure according to claim 1, wherein the inflatable inner casing is further made by a rubber, a mackintosh, a plastic, and other related material which is extendable.

3. The waterproof gate assembly structure according to claim 1, wherein the sheathing layer is further made by a canvas, a plastic fiber, and other related material that is waterproof.

4. The waterproof gate assembly structure according to claim 1, wherein the inflatable inner casing is provided with the nozzle through which gas is filled into the inflatable inner casing.

5. The waterproof gate assembly structure according to claim 1, wherein the locking element is further a button, a zipper, a Velcro tape, or other related material that opens the sheathing layer.
